(19) United States
(12) Patent Application Publication
(10) Pub. No.: US 2025/0217108 A1
(43) Pub. Date: Jul. 3, 2025

(54) MEMORY APPARATUS FOR PERFORMING PIM AND OPERATING METHOD THEREOF

(71) Applicant: SAMSUNG ELECTRONICS CO., LTD., SUWON-SI (KR)

(72) Inventors: WON-JO LEE, SUWON-SI (KR); SANGHOON CHA, SUWON-SI (KR); SUNJUNG LEE, SUWON-SI (KR)

(21) Appl. No.: 19/003,198

(22) Filed: Dec. 27, 2024

(30) Foreign Application Priority Data
Jan. 3, 2024 (KR) 10-2024-0001028

(51) Int. Cl. G06F 7/523; G06F 7/50

(52) U.S. Cl. CPC G06F 7/523; G06F 7/50

(57) ABSTRACT

A memory apparatus is configured to perform a processing-in-memory (PIM) operation. The memory apparatus includes a weight handler circuit configured to receive weights from a memory bank, a multiply-accumulate (MAC) circuit, and a register file configured to store input data and an operation result. The weight handler circuit is configured to adjust a distribution of the weights based on a specification of the MAC circuit, and the MAC circuit is configured to perform an operation on the input data received from the register file and the weights based on a result of the distribution of the weights, to generate the operation result.

### CROSS-REFERENCE TO RELATED APPLICATIONS

This patent application claims priority under 35 USC § 119 (a) to Korean Patent Application No. 10-2024-0001028, filed on Jan. 3, 2024, in the Korean Intellectual Property Office, the entire disclosure of which is incorporated by reference in its entirety herein.

### 1. TECHNICAL FIELD

One or more embodiments are directed to a memory apparatus for performing a processing-in-memory (PIM) operation and an operating method thereof.

### 2. DISCUSSION OF RELATED ART

Processing-in-memory (PIM) may refer to a computing architecture in which a memory and processor are tightly integrated or in the same physical location. In a von Neumann computing architecture, the memory device is separate in function from the processor that performs operation tasks. In the PIM architecture, processing and memory functions are performed in the same physical location, and if possible, in the same hardware component.

PIM reduces the movement of data between the processor and the memory, which may increase speed and efficiency. The PIM architecture may increase the performance of calculations, especially those involving large datasets, by placing processing close to the data.

### SUMMARY

According to an aspect, there is provided a memory apparatus for performing a processing-in-memory (PIM) operation. The memory apparatus includes a weight handler circuit configured to receive weights from a memory bank, a multiply-accumulate (MAC) circuit, and a register file configured to store input data and an operation result. The weight handler circuit is configured to adjust a distribution of the weights based on a specification of the MAC circuit. The MAC circuit is configured to perform an operation on the input data received from the register file and the weights based on a result of the distribution of the weights, to generate the operation result.

The specification of the MAC circuit may include information indicating at least one of the number of MAC units included in the MAC circuit and an operation frequency of the MAC units.

The weight handler circuit may include at least one of a broadcasting unit, an asynchronous first-in-first-out (FIFO), and a buffer.

The weight handler circuit may be configured to distribute the weights to the MAC units through the broadcasting unit so that the MAC is configured to perform an operation corresponding to the number of MAC units.

The weight handler circuit may be configured to transmit the weights to the MAC circuit through the asynchronous FIFO according to the operation frequency of the MAC units.

The weight handler circuit may be configured to reuse the weights by storing the weights in the buffer to enable the MAC circuit to perform an operation corresponding to the operation frequency of the MAC units.

The weight handler circuit may be configured to input the weights to the asynchronous FIFO and configured to distribute the weights output from the asynchronous FIFO to the MAC units through the broadcasting unit and the buffer.

The register file may include one or more scalar register files (SRFs) or one or more vector register files (VRFs).

The memory bank may include dynamic random-access memory (DRAM).

According to another aspect, there is provided an operating method of a memory apparatus that performs a PIM operation. The operating method includes: storing input data in a register file; transmitting weights to a weight handler circuit by reading the weights from a memory bank; adjusting a distribution of the weights through the weight handler circuit based on a specification of the MAC circuit; performing an operation on the input data received from the register file and the weights based on a result of the distribution of the weights to a result; and storing the result in the register file.

The specification of the MAC may include information indicating at least one of the number of MAC units included in the MAC circuit and an operation frequency of the MAC units.

The adjusting of the distribution of the weights may include distributing the weights using at least one of a broadcasting unit, an asynchronous first-in-first-out (FIFO), and a buffer, which are included in the weight handler circuit.

The adjusting of the distribution of the weights may include distributing the weights to enable the MAC units to perform an operation simultaneously using the broadcasting unit based on the number of MAC units.

The adjusting of the distribution of the weights may include transmitting the weights to the MAC circuit through the asynchronous FIFO according to the operation frequency of the MAC units.

The transmitting of the weights to the MAC may further include storing the weights in the buffer to enable the MAC circuit to perform an operation corresponding to the frequency of the MAC units using the buffer that reuses the weights.

The adjusting of the distribution of the weights may include inputting the weights to the asynchronous FIFO and distributing the weights output from the asynchronous FIFO to the MAC units through the broadcasting unit and the buffer.

The register file may include one or more SRFs or one or more VRFs.

The memory bank may include DRAM.

According to an aspect, there is provided a memory apparatus for performing a processing-in-memory (PIM) operation. The memory apparatus includes a memory bank, a MAC circuit, a control circuit, and a sensing amplifier. The memory bank stores a plurality of weights. The MAC circuit includes a plurality of MAC units. The control circuit configured to determine subsets of the weights based on a specification of the MAC circuit and output each of the subsets to a respective one of the MAC units to enable the MAC units to perform a different part of the PIM operation for generating a result. The sensing amplifier is configured to read the weights from the memory bank for output to the control circuit. The memory apparatus may further include comprising a register file for storing the result. The MAC circuit may perform the PIM operation on input data stored in the register file and the weights.

### BRIEF DESCRIPTION OF THE DRAWINGS

These and/or other aspects and features of the inventive concept will become apparent and more readily appreciated from the following description of embodiments, taken in conjunction with the accompanying drawings of which:

FIG. 1 is a schematic diagram illustrating a processing-in-memory (PIM) operation of a memory apparatus, according to a comparative embodiment;

FIG. 2 is a schematic block diagram illustrating a memory apparatus according to an embodiment;

FIG. 3 is a flowchart illustrating an operation of a memory apparatus according to an embodiment;

FIG. 4 is a schematic diagram illustrating a structure of a memory apparatus including PIM units, according to an embodiment;

FIG. 5 is a schematic diagram illustrating an example of a PIM operation according to a comparative embodiment;

FIG. 6 is a schematic diagram illustrating a PIM operation using a weight handler, according to an embodiment;

FIGS. 7 and 8 are schematic block diagrams illustrating a PIM operation using a plurality of multiply-accumulate (MAC) units, according to an embodiment; and

FIGS. 9 to 11 are schematic block diagrams illustrating a PIM operation using one or more MAC units, according to an embodiment.

### DETAILED DESCRIPTION

The following description is provided as examples of certain embodiments of the inventive concept that may be implemented. However, the inventive concept is not limited to these embodiments since various alterations and modifications may be made to the examples. Thus, the embodiments are understood to include all changes, equivalents, and replacements within the technical scope of this description.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. “ ” “ ” “ ” As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

The examples may be implemented as various types of products, such as, for example, a personal computer (PC), a laptop computer, a tablet computer, a smartphone, a television (TV), a smart home appliance, an intelligent vehicle, a kiosk, and a wearable device. Hereinafter, embodiments will be described in detail with reference to the accompanying drawings. When describing the embodiments with reference to the accompanying drawings, like reference numerals refer to like elements and a repeated description related thereto will be omitted.

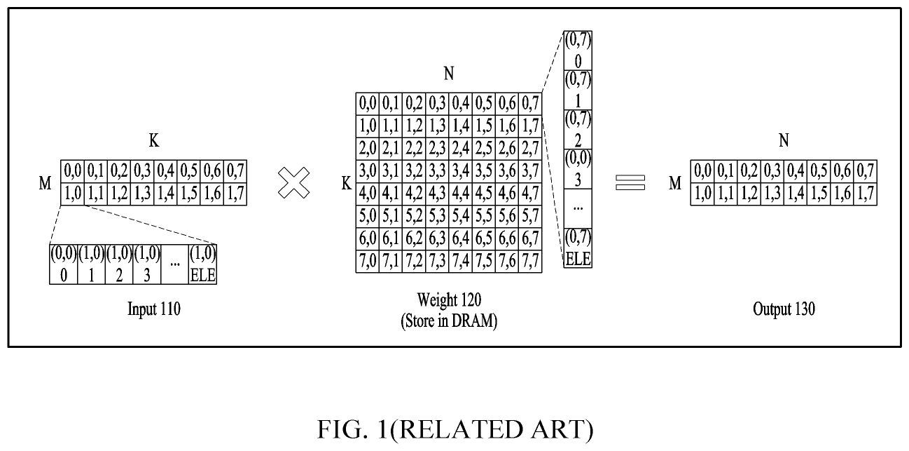

FIG. 1 is a schematic diagram illustrating a processing-in-memory (PIM) operation of a memory apparatus, according to a comparative embodiment.

Referring to FIG. 1, a memory apparatus needs to repeat reading an input 110 and reading a weight 120 M times to perform a PIM operation on the input 110 when M vectors are received as the input 110. That is, when the input 110 is an input matrix of M×K, the memory apparatus may need to read the M vectors of the input 110 K times. Accordingly, the memory apparatus may need to read the input 110, M×K M times overall. When the weight 120 is a matrix of K×N, the memory apparatus may need to read the weight 120 corresponding to each row, M times. Since the memory apparatus needs to read the weight 120 M times, the memory apparatus may need to read the weight 120, M×N times overall. The memory apparatus may perform an operation on each vector of the input 110 using the weight 120. Accordingly, the memory apparatus may generate an output 130 of an M×N size.

The PIM operation may use a decoder-based large language model (LLM) as an acceleration target. The decoder-based LLM is a type of language model mainly used in the field of natural language processing (NLP). The decoder-based LLM mainly uses a sequence-to-sequence learning structure, which may be particularly suitable for machine translation and language generation tasks. In the decoder-based LLM, batch_size and beam_size are parameters used in the training and inference process of a model. The batch_size may represent the number of samples of input data processed by a model at once. The beam_size may represent the number of candidates selected from various candidates generated in a decoder and may refer to a weight stored in a memory.

Depending on the values of the batch_size and beam_size, the decoder-based LLM may operate to process basic linear algebra subprograms level 2 (BLAS2) (general matrix-vector multiplication (GEMV)) operation in a feed-forward neural network (FFN) and multi-head self-attention (MHA), using a PIM operation. The FFN is a basic form of a neural network, which may have a structure in which information flows in only one direction. The MHA is an attention mechanism mainly used in a model such as a transformer. The FFN and MHA may be used as components to train the representation of text and sequence data in a model such as a transformer.

In the decoder-based LLM that performs a PIM operation according to a comparative embodiment, when the batch_size increases or the beam_size increases, it may be necessary for the FFN to be processed using a BLAS3 (general matrix-matrix multiplication (GEMM)) operation instead of the BLAS2 operation. That is, the PIM operation according to this comparative embodiment needs to perform the BLAS2 operation independently on each input 110 while reloading each weight 120, so the acceleration performance of the PIM according to the comparative embodiment may be reduced. As there is a situation in which the M size increases depending on the batch_size and beam_size, the time to produce an operation result may also increase according to M in the PIM operation according to this comparative embodiment. Accordingly, when a user uses a product to which PIM operation is applied, the time to receive a result may increase as the M size of an operation of the input 110 increases. Here, the BLAS2 operation is matrix-vector multiplication, which may independently perform an operation on each vector. The BLAS3 operation is matrix-matrix multiplication, which may perform an operation on a larger matrix with higher operation efficiency compared to a vector.

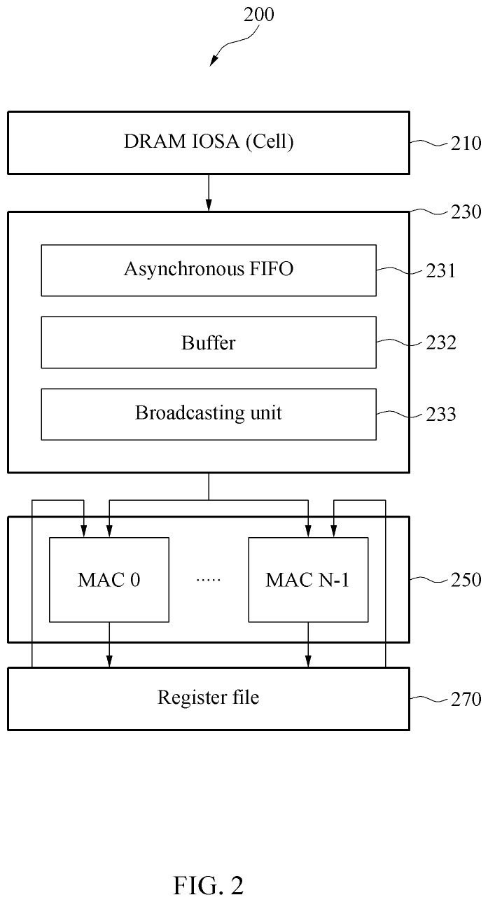

FIG. 2 is a schematic block diagram illustrating a memory apparatus 200 according to an embodiment.

In FIG. 2, one or more blocks and a combination thereof may be implemented by a special-purpose memory apparatus that performs a predetermined function or a combination of a special-purpose memory controller and instructions.

the memory apparatus 200 according to an embodiment includes a dynamic random-access memory (DRAM) input/output sensing amp (IOSA) (cell) 210, a weight handler 230 (e.g., a weight handler circuit or a control circuit), a multiply-accumulate (MAC) circuit 250, and a register file 270. The memory apparatus 200 may store weights in a DRAM bank. The DRAM IOSA 210 may be implemented by a sensing amplifier. The MAC circuit 250 may be implemented by one or more digital signal processor (DSP) cores, field-programmable gate arrays (FPGAs), application-specific integrated circuits (ASICs), microprocessors, microcontrollers, or graphics processing units (GPUs).

The DRAM IOSA 210 according to an embodiment detects and amplifies an electrical signal in a memory cell (e.g., a DRAM cell), which may be used in the process of reading and writing data. The DRAM IOSA 210 may detect a state of charge of the DRAM cell and may convert the state of charge of the DRAM cell into a digital signal. In addition, the DRAM IOSA 210 may select data of the DRAM cell from a row buffer. For example, when there is a row buffer of 2 kilobytes (KB), the DRAM IOSA 210 may select 256 bits from the row buffer. Accordingly, the memory apparatus 200 may read the weights stored in the DRAM bank using the DRAM IOSA 210.

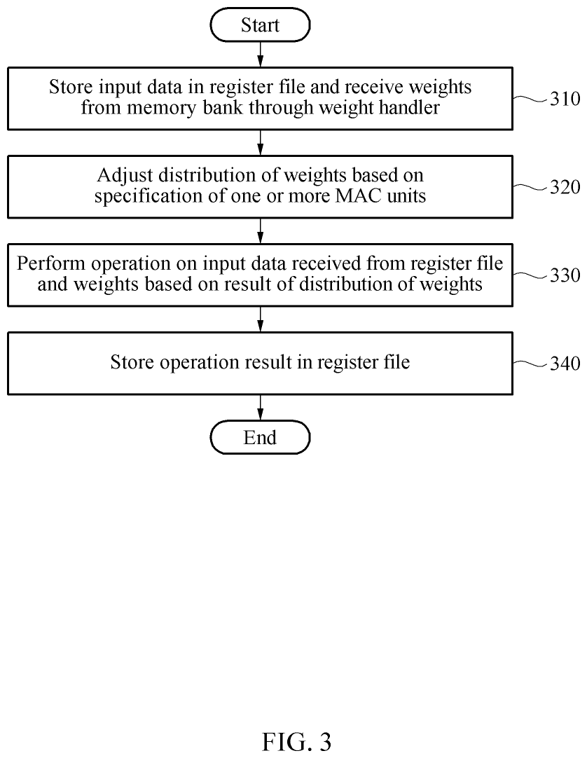

When a plurality of MAC units or a single MAC unit operating at a higher frequency than the plurality is used for a PIM operation, the memory apparatus 200 may quickly perform the PIM operation by appropriately distributing the weights to be calculated or reusing the weights. An operation of the memory apparatus 200 is described in detail below with reference to FIG. 3.

FIG. 3 is a flowchart illustrating an operation of a memory apparatus according to an embodiment.

The description provided with reference to FIGS. 1 and 2 may apply to FIG. 3, and any repeated description related thereto may be omitted.

For ease of description, operations 310 to 340 are described as being performed by the memory apparatus 200 illustrated in FIG. 2. However, operations 310 to 340 may be performed by another suitable electronic device in a suitable system.

The operations of FIG. 3 may be performed in the shown order and manner. However, the order of some operations may be changed or omitted without departing from the spirit and scope of the shown embodiment. The operations shown in FIG. 3 may be performed in parallel or simultaneously.

In operation 310, the memory apparatus 200 stores input data in the register file 270 and reads weights from a memory bank (e.g., a DRAM bank). The memory apparatus may transmit the read weights to the weight handler 230. DRAM is a type of volatile computer memory widely used in electronic devices. The register file 270 may include a plurality of registers.

In operation 320, the memory apparatus 200 adjusts the distribution of the based on a specification of the MAC circuit 250. The weight handler 230 of the memory apparatus 200 may adjust the distribution of the weights. The weight handler 230 may include at least one of an asynchronous first-in-first-out (FIFO) 231, a buffer 232, and a broadcasting unit 233 (e.g., a broadcasting circuit, a distribution circuit). The broadcasting unit 233 may consist of at least of a data bus, a crossbar switch, a network-on-chip (NoC) or a direct memory access (DMA) controller. In the memory apparatus 200, the DRAM IOSA 210 may read the weights from the DRAM bank and may transmit the read weights to the weight handler 230, and the weight handler 230 may distribute the read weights to the MAC circuit 250

The asynchronous FIFO 231 may be used to independently transmit and process data. A FIFO refers to a data structure in which first input data is output first when data is input. The FIFO may be used when data needs to be asynchronously received from a memory in a PIM operation. This asynchronous feature may indicate that data is independently transmitted without being synchronized with a clock signal or a timing signal, and accordingly, the arrival and output of the data may vary over time. That is, the asynchronous FIFO 231 may be used to transmit data asynchronously from a memory to a PIM apparatus, or vice versa, to transmit data asynchronously from the PIM apparatus to the memory. The asynchronous FIFO 231 may or may not be used depending on the weights received from the weight handler 230.

The buffer 232 according to an embodiment may temporarily store the weights so that an operation corresponding to the frequency of MAC units may be performed.

The broadcasting unit 233 according to an embodiment transmits a same weight value to at least two MAC units simultaneously. For example, when trying to perform an operation on different input vectors A and B, the broadcasting unit 233 may transmit weights W to different MAC units so that at least an A*W operation and an B*W operation may be performed in the same cycle.

In operation 330, the memory apparatus 200 performs an operation on the input data received from the register file 270 and the weights based on a result of the distribution of the weights, to generate an operation result. The MAC 250 circuit may include one or more MAC units (e.g., MAC 0, MAC 2, . . . , MAC N−1). The specification of the MAC circuit 250 may refer to at least one of a plurality of pieces of information on the number of MAC units included in the MAC circuit 250 and the operation frequency of the MAC units included in the MAC circuit 250. The specification may further include a bit width or number of bits the MAC circuit 250 is capable of processing per unit time, the number of MAC operations that can be performed by the MAC circuit per unit time, an amount of time it takes for the MAC circuit 250 to perform a single operation, the amount of power consumed by the MAC to perform a single operation, etc. The MAC circuit 250 may include a plurality of MAC units having the same operating frequency and may further include a single MAC unit or a plurality of MAC units having a higher frequency. For example, assuming that there are six MAC units included in the MAC circuit 250, MAC 0 to MAC 4 may have a frequency capable of calculating 128 bits in a time period, but MAC 5 may have a frequency capable of calculating 256 bits in the same time period.

The weight handler 230 according to an embodiment adjusts the distribution of the weights based on the specification of the MAC 250. The weight handler 230 may distribute the weights using the broadcasting unit 233 so that the MAC units simultaneously perform an operation in response to the number of MAC units. The weight handler 230 may transmit the weights to the MAC circuit 250 through the asynchronous FIFO 231 in response to the frequency of the MAC units. The weight handler 230 may reuse the weights by storing the weights in the buffer 232 so that the MAC circuit 250 may perform an operation corresponding to the frequency of the MAC units. The weight handler 230 may input the weights to the asynchronous FIFO 231 in response to the specification of the MAC circuit 250 and may distribute the weights output from the asynchronous FIFO 231 to the MAC units through the broadcasting unit 233 and the buffer 232. For example, distributing the weights may mean routing a first number of the weights to the first MAC unit, a second number of the weights to the second MAC, and a remaining number of the weights to the n-th MAC unit.

For example, assuming that there are N MAC units capable of calculating 128 bits, the weight handler 230 may distribute the weights so that the MAC circuit 250 may perform an operation of 128 bits×N at once through the broadcasting unit 233. That is, unlike typically performing the BLAS2 (GEMV) operation using a single MAC unit, the BLAS3 (GEMM) operation may be performed using N MAC units at the same time. In this example, each of the MAC units could perform an operation on a different 128 bits at the same time.

In another example, assuming that the memory apparatus 200 has a MAC unit with a frequency of 512 bits, the weight handler 230 may distribute the weights through the asynchronous FIFO 231 and the buffer 232 so that the MAC 250 may perform an operation of 128 bits×4 at once. That is, even when the typical memory apparatus is equipped with a MAC unit of 512 bits, when the typical memory apparatus supports only an operation of 128 bits, only the operation of 128 bits may be performed. On the other hand, when the buffer 232 of the weight handler 230 is used, the weight handler 230 may store weights read one time in the buffer 232, may reuse the stored weights, and may distribute the stored weights so that the MAC circuit 250 may perform an operation on 128 bits×4 at one timing.

The weight handler 230 according to an embodiment may perform both of the foregoing examples at once. For example, it is assumed that there are four MAC units that each calculate 128 bits in a time period, and one MAC unit that calculates 512 bits in the time period. Here, the weight handler 230 may distribute the weights through the broadcasting unit 233 to a MAC unit of 128 bits by dividing the weights into four weights and may reuse the weights using the buffer 232 so that the MAC unit of 512 bits may perform an operation of 128 bits×4 at once. Accordingly, the weight handler 230 may appropriately distribute and reuse the weights, allowing the memory apparatus 200 to perform an operation of 128 bits×8 at once. Unlike performing the BLAS2 operation by the typical memory apparatus, the weight handler 230 may adjust the distribution of the weights so that the BLAS3 operation is performed in the same latency.

In the weight handler 230, the buffer 232 may be used selectively according to the operation frequency of the MAC units, and the broadcasting unit 233 may be used to distribute the weights to the MAC units connected to the weight handler 230.

In operation 340, the memory apparatus 200 stores the operation result in the register file 270. The register file 270 may include one or more scalar register files (SRFs) or one or more vector register files (VRFs).

An SRF may refer to a register used to perform a scalar operation. The scalar operation is an operation on a single value, and the SRF may store data used in a scaler operation. For example, the SRF may be used to process an operation on a single number or scalar.

A VRF may refer to a register used to perform a vector operation. The vector operation processes a plurality of values at the same time, and the VRF may store data used in a vector operation in a vector. The VRF is useful for dealing with a data block including a plurality of elements and may be integrated directly with a memory in PIM to efficiently perform the vector operation. The embodiments described herein are described as being performed using the VRF but are not limited thereto.

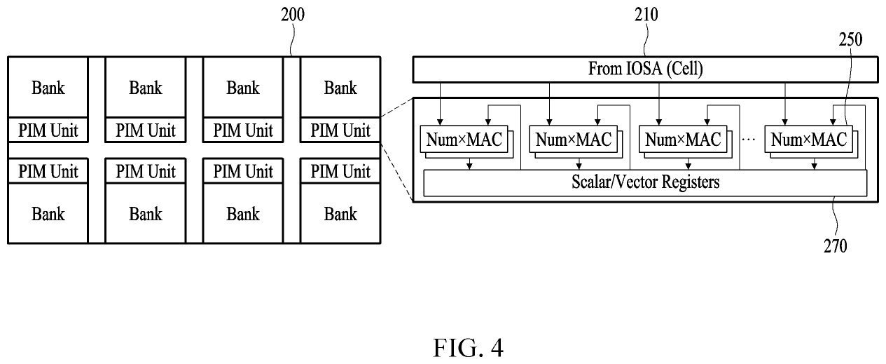

FIG. 4 is a schematic diagram illustrating a structure of a memory apparatus including PIM units, according to an embodiment.

The description provided with reference to FIGS. 1 to 3 may apply to FIG. 4, and any repeated description related thereto may be omitted.

The memory apparatus 200 according to an embodiment may include a plurality of memory banks and a plurality of PIM units. The PIM units may also be referred to as PIM engines and may be implemented by logic circuit or processors. Each of the plurality of PIM units may include the weight handler 230 described above. The memory banks may store weights, and the memory apparatus 200 may transmit the weights stored in the memory banks to the weight handler 230 using the DRAM IOSA 210 for a PIM operation, may perform an operation (e.g., multiplication) on an input and the weights in the MAC 250 by reading a vector corresponding to the input or a plurality of vectors from the register file 270 to generate an operation result, and then may return the operation result to the register file 270.

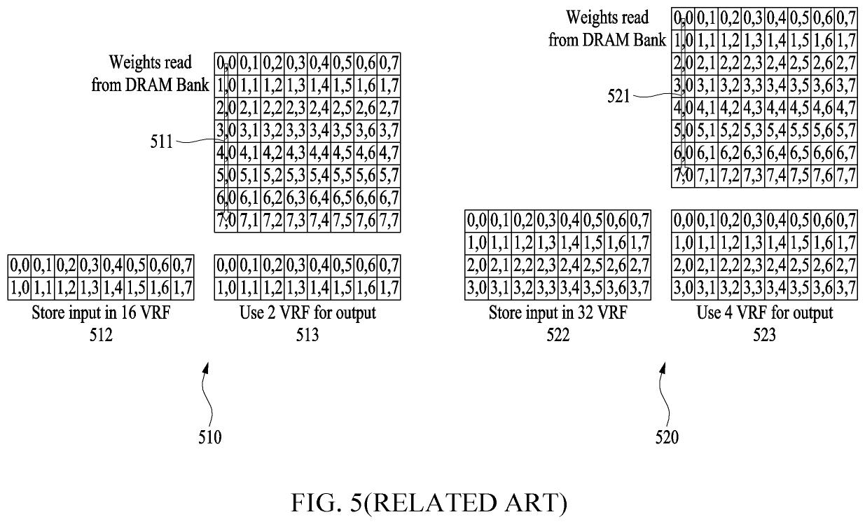

FIG. 5 is a schematic diagram illustrating an example of a PIM operation according to a comparative embodiment.

Referring to FIG. 5, operation 510 is an operation when there are two input vectors and operation 520 is an operation when there are four input vectors. A memory apparatus according to this comparative embodiment may read weights from the DRAM IOSA 210 and may perform a GEMV operation on input vectors.

In the operation 510, the memory apparatus according to this comparative embodiment may perform an operation on a first column weight value 511 of the weights and input vector 512 stored in a VRF to generate an output vector 513. To output an output of {(0,0), (1,0)} of the output vector 513, the memory apparatus according to this comparative embodiment may need to read the first column weight value 511 twice to perform an operation on the input vector 512. That is, to complete all operations on the input vector 512, the memory apparatus according to this comparative embodiment may need to read each column of the weights twice to perform an operation.

Similarly, in the operation 520, the memory apparatus according to this comparative embodiment may perform an operation on an input vector 522 stored in the VRF using a first column weight value 521 of the weights to generate an output vector 523. To output an output of {(0,0), (1,0), (2,0), (3,0)} of the output vector 523, the memory apparatus according to this comparative embodiment may need to read the first column weight value 521 four times to perform an operation on the input vector 522. That is, to complete all operations on the input vector 522, the memory apparatus according to this comparative embodiment may need to read each column of the weights four times to perform an operation.

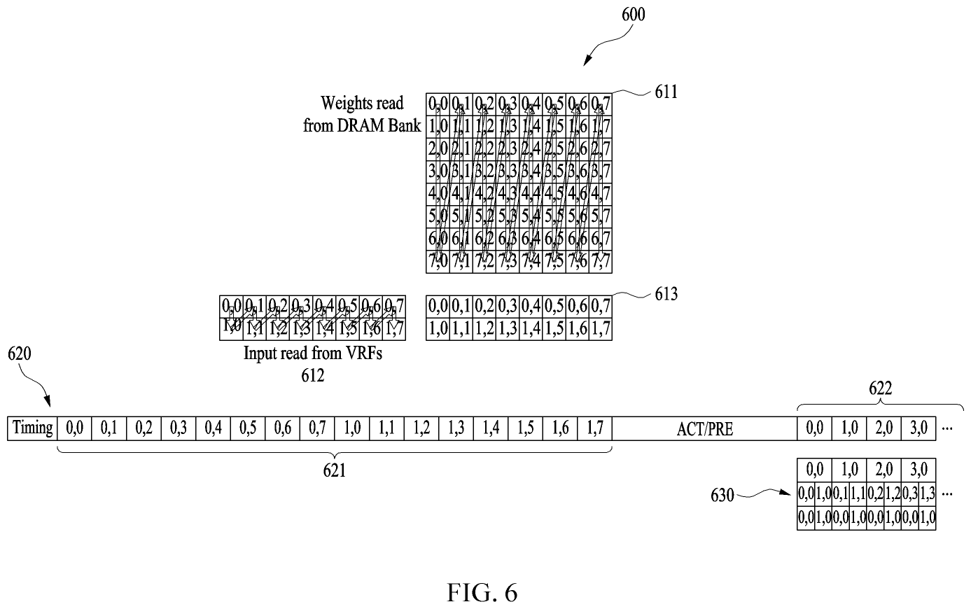

FIG. 6 is a schematic diagram illustrating a PIM operation by a weight handler (e.g., 230), according to an embodiment.

The description provided with reference to FIGS. 1 to 5 may apply to FIG. 6, and any repeated description related thereto may be omitted.

Referring to FIG. 6, a timing diagram 620 displays operation 600 for each timing, and an operation result table 630 displays a weight, input, and operation result in the operation process.

At timing 621, the memory apparatus 200 first stores (or reads) an input vector 612 in a VRF to perform the operation 600 when there are two input vectors 612. Thereafter, the memory apparatus 200 may perform an ACT/PRE process and may prepare for an operation.

At timing 622, the memory apparatus 200 may read weights from a DRAM bank. Here, the weight handler 230 may distribute the weights through the broadcasting unit 233 or may reuse the weights through the buffer 232, based on the specification of the MAC circuit 250. As shown in the operation result table 630, the weight handler 230 may perform an operation on the input vector 612 using twice the weights read one time. That is, unlike FIG. 5, the weights are not read continuously for each input vector, but the weights read one time may be distributed to two MAC units or the weights may be read only one time even when there are two input vectors 612 using the weights twice in the MAC unit that has a high operation frequency.

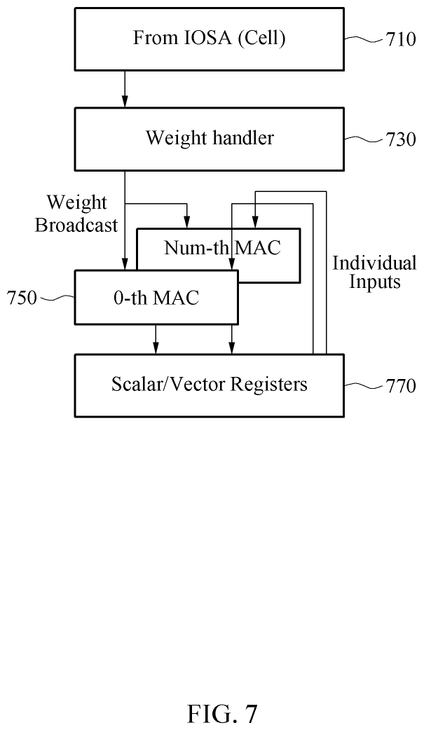

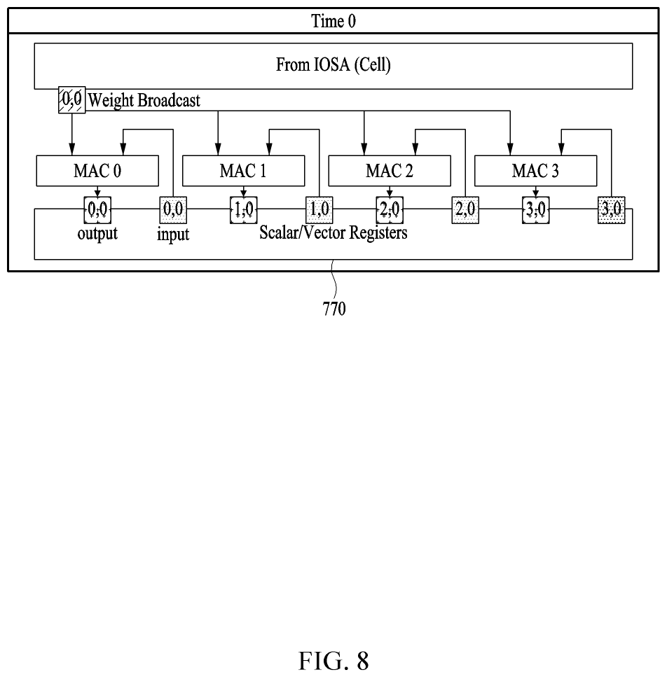

FIGS. 7 and 8 are schematic block diagrams illustrating a PIM operation using a plurality of MAC units, according to an embodiment.

The description provided with reference to FIGS. 1 to 6 may apply to FIGS. 7 and 8, and any repeated description related thereto may be omitted.

Referring to FIG. 7, a MAC circuit 750 according to an embodiment includes N MAC units. Each MAC unit may perform an operation by receiving input data stored in a register file 770 and weights read by a weight handler 730 from an IOSA (cell) 710.

FIG. 8 shows a distribution of weights when the MAC circuit 750 according to an embodiment includes four MAC units. The weight handler 730 may uniformly distribute a weight (0,0) read one time to each of the four MAC units. Accordingly, each MAC unit may output an output by receiving the single weight (0,0) received from the weight handler 730 and the input received from the register file 770. For example, MAC 0 may output an output (0,0) by receiving the weight (0,0) from the weight handler 730 and an input (0,0) from the register file 770. MAC 1 may output an output (1,0) by receiving the weight (0,0) from the weight handler 730 and an input (1,0) from the register file 770. MAC 2 may output an output (2,0) by receiving the weight (0,0) from the weight handler 730 and an input (2,0) from the register file 770. MAC 3 may output an output (3,0) by receiving the weight (0,0) from the weight handler 730 and an output (3,0) from the register file 770. That is, the weight handler 730 may allow the memory apparatus 200 to perform a GEMV operation four times during the same time.

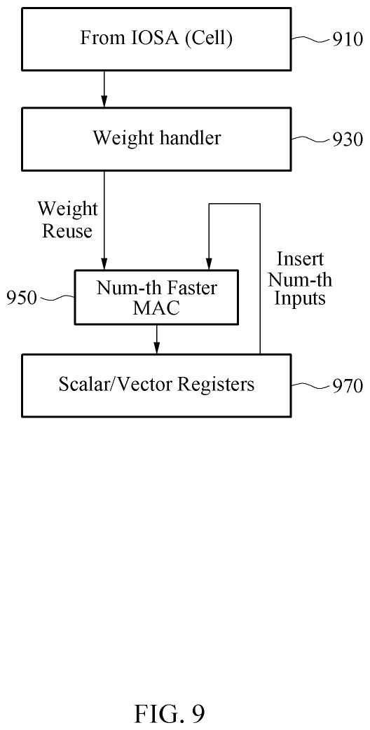

FIGS. 9 to 11 are schematic block diagrams illustrating a PIM operation using one or more MAC units, according to an embodiment. In an embodiment, the MAC units of FIGS. 9 to 11 operate faster or process data more quickly than previously described MAC units.

The description provided with reference to FIGS. 1 to 8 may apply to FIGS. 9 to 11, and any repeated description related thereto may be omitted.

Referring to FIG. 9, a faster MAC circuit 950 according to an embodiment may include N faster MAC units. Each faster MAC unit may perform an operation by receiving an input stored in a register file 970 and weights read by a weight handler 930 from an IOSA (cell) 910.

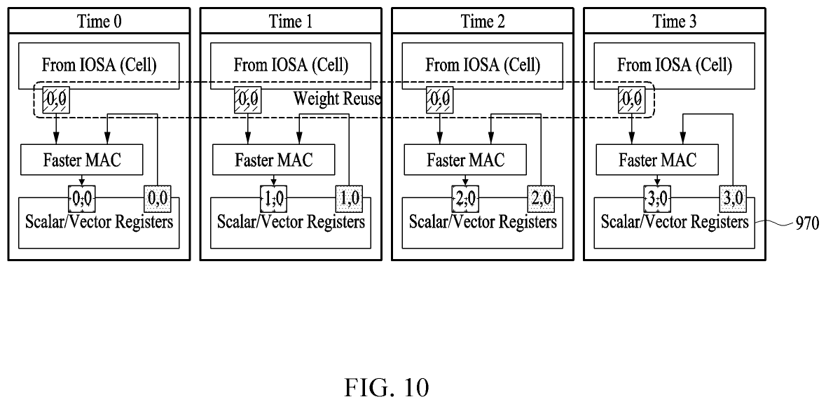

FIG. 10 shows reuse of weights when the faster MAC circuit 950 according to an embodiment includes one faster MAC unit. In an embodiment, the faster MAC unit has an operation frequency that is four times faster than the previously described MAC unit, but is not limited thereto. For example, the faster MAC unit could be two times fast, three times, eight times faster, etc. The weight handler 930 may reuse a weight (0,0) read one time according to the frequency timing of one faster MAC unit. Accordingly, the faster MAC unit may output an output by receiving the weight (0,0) received from the weight handler 930 and the input received from the register file 970. For example, the faster MAC unit may output an output (0,0) at Time 0 by receiving the weight (0,0) from the weight handler 930 and an input (0,0) from the register file 970. The faster MAC unit may output an output (1,0) at Time 1 by reusing the weight (0,0) stored in a buffer of the weight handler 930 and receiving an input (1,0) from the register file 970. The faster MAC unit may output an output (2,0) at Time 2 by reusing the weight (0,0) in the buffer of the weight handler 930 and receiving an input (2,0) from the register file 970. The faster MAC unit may output an output (3,0) at Time 3 by receiving the weight (0,0) from the buffer of the weight handler 930 and receiving an input (3,0) from the register file 970. That is, when four MAC units are installed, four GEMV operations performed during the same time may be possible by the weight handler 930.

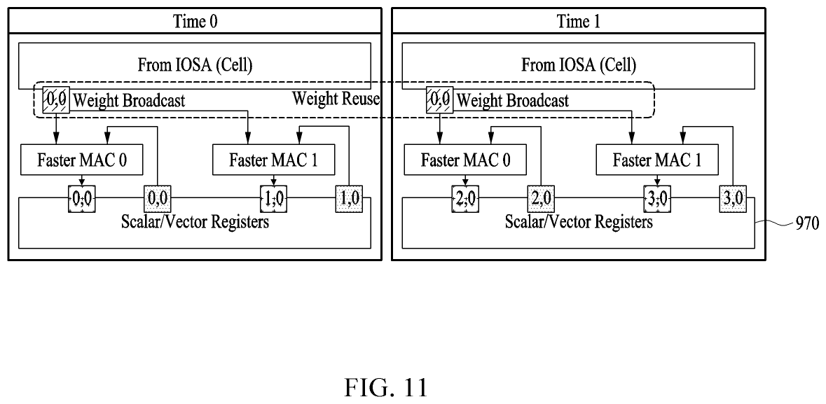

FIG. 11 shows reuse of weights when the faster MAC circuit 950 according to an embodiment includes two faster MAC units. In an embodiment, the faster MAC unit has an operation frequency that is twice as the operation frequency of a normal MAC unit, but is not limited thereto. The weight handler 930 may distribute and reuse the weight (0,0) read one time according to the frequency timing of the two faster MAC units. Accordingly, the faster MAC units may output an output by receiving the weight (0,0) received from the weight handler 930 and the input received from the register file 970. For example, at Time 0, the faster MAC 0 may output an output (0,0) by receiving the weight (0,0) distributed from the weight handler 930 and an input (0,0) from the register file 970. At Time 0, the faster MAC 1 may output an output (1,0) by receiving the weight (0,0) distributed from the weight handler 930 and an input (1,0) from the register file 970. At Time 1, the faster MAC 0 may output an output (2,0) by receiving the weight (0,0) distributed through a broadcasting unit by reusing the weight (0,0) in the buffer of the weight handler 930 and receiving an input (2,0) from the register file 970. At Time 1, the faster MAC 1 may output an output (3,0) by receiving the weight (0,0) distributed through the broadcasting unit by reusing the weights (0,0) in the buffer of the weight handler 930 and receiving an input (3,0) from the register file 970. That is, when four MAC units are installed, four GEMV operations performed at the same time may be possible by the weight handler 930.

It may be possible to mix and use a faster MAC unit and a plurality of normal MAC units.

The examples described herein may be implemented using a hardware component, a software component, and/or a combination thereof. A processing device may be implemented using one or more general-purpose or special-purpose computers, such as, for example, a processor, a controller, an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

Software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Accordingly, other implementations, other embodiments, and equivalents to the claims are also within the scope of the following claims.

What is claimed is:

1. A memory apparatus for performing a processing-in-memory (PIM) operation, the memory apparatus comprising:
a weight handler circuit configured to receive weights from a memory bank;
a multiply-accumulate (MAC) circuit; and
a register file configured to store the input data and an operation result,
wherein the weight handler circuit is configured to adjust a distribution of the weights to MAC units within the MAC circuit based on a specification of the MAC circuit, and
wherein the MAC circuit is configured to perform an operation on the input data received from the register file and the weights based on a result of the distribution of the weights, to generate the operation result.

2. The memory apparatus of claim 1, wherein the specification of the MAC comprises information indicating at least one of a number of MAC units included in the MAC circuit and an operation frequency of the MAC units.

3. The memory apparatus of claim 2, wherein the weight handler circuit comprises at least one of a broadcasting unit, an asynchronous first-in-first-out (FIFO), and a buffer.

4. The memory apparatus of claim 3, wherein the weight handler is configured to distribute the weights to the MAC units through the broadcasting unit so that the MAC is configured to perform an operation corresponding to the number of MAC units.

5. The memory apparatus of claim 3, wherein the weight handler circuit is configured to transmit the weights to the MAC circuit through the asynchronous FIFO according to the operation frequency of the MAC units.

6. The memory apparatus of claim 5, wherein the weight handler circuit is configured to reuse the weights by storing the weights in the buffer to enable the MAC units to perform an operation corresponding to the operation frequency of the MAC units.

7. The memory apparatus of claim 3, wherein the weight handler circuit is configured to input the weights to the asynchronous FIFO and configured to distribute the weights output from the asynchronous FIFO to the MAC units through the broadcasting unit and the buffer.

8. The memory apparatus of claim 1, wherein the register file comprises one or more scalar register files (SRFs) or one or more vector register files (VRFs).

9. The memory apparatus of claim 1, wherein the memory bank comprises dynamic random-access memory (DRAM).

10. An operating method of a memory apparatus that performs a processing-in-memory (PIM) operation, the operating method comprising:
storing input data in a register file;
transmitting weights to a weight handler circuit by reading the weights from a memory bank;
adjusting a distribution of the weights through the weight handler circuit based on a specification of multiply-accumulate (MAC) circuit;
performing an operation on the input data received from the register file and the weights based on a result of the distribution of the weights to generate a result; and
storing the result in the register file.

11. The operating method of claim 10, wherein the specification of the MAC comprises information indicating at least one of a number of MAC units included in the MAC circuit and an operation frequency of the MAC units.

12. The operating method of claim 11, wherein the adjusting of the distribution of the weights comprises distributing the weights using at least one of a broadcasting unit, an asynchronous first-in-first-out (FIFO), and a buffer, which are included in the weight handler circuit.

13. The operating method of claim 12, wherein the adjusting of the distribution of the weights comprises distributing the weights to enable the MAC units to perform an operation simultaneously using the broadcasting unit based on the number of MAC units.

14. The operating method of claim 12, wherein the adjusting of the distribution of the weights comprises transmitting the weights to the MAC circuit through the asynchronous FIFO according to the operation frequency of the MAC units.

15. The operating method of claim 14, wherein the transmitting of the weights to the MAC circuit further comprises storing the weights in the buffer to enable the MAC circuit to perform an operation corresponding to the operation frequency of the MAC units using the buffer that reuses the weights.

16. The operating method of claim 12, wherein the adjusting of the distribution of the weights comprises inputting the weights to the asynchronous FIFO and distributing the weights output from the asynchronous FIFO to the MAC units through the broadcasting unit and the buffer.

17. The operating method of claim 10, wherein the register file comprises one or more scalar register files (SRFs) or one or more vector register files (VRFs).

18. A memory apparatus for performing a processing-in-memory (PIM) operation, the memory apparatus comprising:
a memory bank storing a plurality of weights;
a multiply-accumulate (MAC) circuit comprising a plurality of MAC units;
a control circuit configured to determine subsets of the weights based on a specification of the MAC circuit and output each of the subsets to a respective one of the MAC units to enable the MAC units to perform a different part of the PIM operation for generating a result; and
a sensing amplifier configured to read the weights from the memory bank for output to the control circuit.

19. The memory apparatus of claim 18, further comprising a register file for storing the result.

20. The memory apparatus of claim 19, wherein the MAC circuit performs the PIM operation on input data stored in the register file and the weights.
